(19) United States
(12) Patent Application Publication
(10) Pub. No.: US 2015/0288545 A1
(43) Pub. Date: Oct. 8, 2015

(54) APPARATUS AND METHODS FOR CONTINUOUS-TIME EQUALIZATION

(71) Applicant: ANALOG DEVICES, INC., Norwood, MA (US)

(72) Inventors: Robert Schell, Chatham, NJ (US); Jesse Bankman, Gibsonville, NC (US)

(21) Appl. No.: 14/552,296

(22) Filed: Nov. 24, 2014

Related U.S. Application Data
(60) Provisional application No. 61/974,918, filed on Apr. 3, 2014.

(51) Int. Cl. H04L 25/03

(52) U.S. Cl. CPC H04L 25/03057

(57) ABSTRACT

Apparatus and methods for continuous-time equalization are provided. In one aspect, an apparatus includes an integrator configured to track and process an asynchronous input signal according to actual or approximated frequency-dependent subtraction. The apparatus further includes a comparator or subtractor configured to compare a threshold, output by the integrator, with the asynchronous input signal. In various embodiments, the integrator can include a leaky integrator configured to apply a transform in the form 1/(1+s/γ), wherein s can be adjusted based on the complex angular frequency of the asynchronous input signal. In various embodiments, the integrator can include a programmable network having a resistance R and a capacitance C, and γ can include 1/(RC). In various embodiments, the integrator can include one or more programmable current sources configured to adjust a level of boost in said frequency-dependent subtraction.

### CROSS REFERENCE TO RELATED APPLICATIONS

This application claims the benefit of U.S. Provisional Patent Application No. 61/974,918, entitled “APPARATUS AND METHODS FOR CONTINUOUS-TIME EQUALIZATION,” filed Apr. 3, 2014, which is incorporated by reference in its entirety.

### BACKGROUND

1. Field

Embodiments of the invention relate to electronic devices, and more particularly, to continuous-time equalization.

2. Description of the Related Technology

Signal equalization systems can be used in a variety of applications for recovering data from a high-speed serial data streams. Signal equalization systems can be used in, for example, telecommunications systems, optical networks, and chip-to-chip communication.

Data can be transmitted, for example across backplanes and/or cables (which can be generally referred to as transmission channels). At relatively high frequencies and/or after transmission across relatively long channel lengths, an output waveform can become heavily corrupted. For example, if viewing a “data eye” diagram, the eye can be closed. Even in a noiseless environment, due to band-limiting of a transmit driver and channel, long rise and fall times can start to overlap if the incoming data does not have time to settle to its LOW or HIGH value before the next new data bit is sent.

As band-limited channels can be low-pass in nature, some forms of high-pass filtering can be used. In certain applications, continuous time linear equalizers (CTLEs) can be employed to equalize the end-to-end response such that the data is more easily recognizable as 0s and 1s. Because a given channel is often unknown in advance, the receive equalizer can be to provide different amounts of equalization difference between high-frequency gain and low-frequency gain can be referred to as “boost.” In order to make a CTLE programmable, CTLEs can rely on switchable resistors and capacitors. This approach can disrupt layout and increase cell area and parasitics. In other applications, synchronous systems (where the input data is sampled) can employ decision feedback equalization (DFE) to alter the threshold input to a slicer dynamically. That approach, however, is not applicable to systems that have receivers that are not sampled (such as in routing switch products).

There is a need for signal equalization systems having improved performance. Additionally, there is need for improved systems and methods for continuous-time equalization.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

One aspect of the subject matter described in the disclosure provides an apparatus. The apparatus includes an integrator configured to track and process an asynchronous input signal according to actual or approximated frequency-dependent subtraction. The apparatus further includes a comparator or subtractor configured to compare a threshold, output by the integrator, with the asynchronous input signal. In various embodiments described herein, while systems configured to track and process the input signal can be referred to as an “integrator,” a person having ordinary skill in the art will appreciate that in some embodiments, the integrator does not necessarily perform a pure integration function. In various embodiments, systems configured to track and process the input signal can be referred to as a “past time filter.”

In various embodiments, the integrator can include a leaky integrator configured to apply a transform in the form 1/(1+s/γ+s²/w+ . . . ), wherein s can be adjusted based on the complex angular frequency of the asynchronous input signal. In various embodiments, the integrator can include a programmable network having a resistance R and a capacitance C, and γ can include 1/(RC). In various embodiments, the integrator can include one or more programmable current sources configured to adjust a level of boost in said frequency-dependent subtraction.

In various embodiments, the integrator can include a first sub-integrator configured to integrate the asynchronous input signal. The integrator can further include a delay circuit configured to provide a delayed input signal. The integrator can further include a second sub-integrator configured to integrate the delayed input signal. The integrator can further include a subtractor configured to subtract an output of the second sub-integrator from an output of the first sub-integrator.

In various embodiments, the first and second sub-integrators can be each configured to apply a transform in the form 1/s, wherein s can be adjusted based on the complex angular frequency of the asynchronous input signal. In various embodiments, the first sub-integrator can be configured to apply a transform in the form 1/(1+s/p1), wherein s can be adjusted based on the complex angular frequency of the asynchronous input signal, and p1 corresponds to a first pole. The second sub-integrator can be configured to apply a transform in the form 1/(1+s/p2), wherein s can be adjusted based on the complex angular frequency of the asynchronous input signal, and p\2 corresponds to a first pole.

In various embodiments, the integrator and comparator or subtractor can be configured in a feed-back configuration. In various embodiments, the integrator and comparator or subtractor can be configured in a feed-forward configuration.

Another aspect provides a method of continuous-time equalization. The method includes integrating an asynchronous input signal according to actual or approximated frequency-dependent subtraction. The method further includes comparing a threshold, based on said integrating, with the asynchronous input signal.

In various embodiments, said tracking and processing can include applying a transform in the form 1/(1+s/γ+s²/w+ . . . ), wherein s can be adjusted based on the complex angular frequency of the asynchronous input signal. In various embodiments, said tracking and processing can include programming a network having a resistance R and a capacitance C, and γ can include 1/(RC). In various embodiments, said tracking and processing can include programming one or more current sources configured to adjust a level of boost in said frequency-dependent subtraction.

In various embodiments, said tracking and processing can include performing a first sub-integration on the asynchronous input signal. Said integrating can further include providing a delayed input signal. Said integrating can further include performing a second sub-integration on the delayed input signal. Said integrating can further include subtracting a result of the second sub-integration from a result of the first sub-integration.

In various embodiments, performing the first and second sub-integrations each comprise applying a transform in the form 1/s, wherein s can be adjusted based on the complex angular frequency of the asynchronous input signal. In various embodiments, performing the first sub-integration can include applying a transform in the form 1/(1+s/p1), wherein s can be adjusted based on the complex angular frequency of the asynchronous input signal, and p1 corresponds to a first pole. Performing the second sub-integration can include applying a transform in the form 1/(1+s/p2), wherein s can be adjusted based on the complex angular frequency of the asynchronous input signal, and p\2 corresponds to a first pole.

In various embodiments, said comparing the threshold can include determining the threshold based on a feed-back loop. In various embodiments, said comparing the threshold can include determining the threshold based on a feed-forward signal flow.

Another aspect provides an apparatus for continuous-time equalization. The apparatus includes means for integrating an asynchronous input signal according to actual or approximated frequency-dependent subtraction. The apparatus further includes means for comparing a threshold, based on said integrating, with the asynchronous input signal.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A-1B are an exemplary signal diagrams that compare how different data patterns can become degraded when transmitted through a lossy channel.

FIG. 2 is a schematic block diagram illustrating one embodiment of a continuous-time equalization system.

FIG. 3 is a schematic block diagram illustrating another embodiment of a continuous-time equalization system.

FIG. 4 is a schematic block diagram illustrating another embodiment of a continuous-time equalization system.

FIG. 5 is a circuit diagram illustrating an embodiment of a continuous-time equalization system.

FIG. 6 is a schematic block diagram illustrating another embodiment of a continuous-time equalization system.

FIG. 7 is a schematic block diagram illustrating another embodiment of a continuous-time equalization system.

FIG. 8 is a schematic block diagram illustrating another embodiment of a continuous-time equalization system.

FIG. 9 is a flowchart of an exemplary process of continuous-time equalization.

FIG. 10 is a functional block diagram of an apparatus for continuous-time equalization, in accordance with an embodiment of the invention.

FIG. 11 shows a data eye diagram before and after equalization according to various implementations herein.

### DETAILED DESCRIPTION OF EMBODIMENTS

The following detailed description of embodiments presents various descriptions of specific embodiments of the invention. However, the invention can be embodied in a multitude of different ways as defined and covered by the claims. In this description, reference is made to the drawings where like reference numerals indicate identical or functionally similar elements.

Apparatus and methods for continuous-time equalization are provided. In certain implementations, an apparatus includes an integrator configured to track and process an asynchronous input signal according to actual or approximated frequency-dependent subtraction. As used herein, an asynchronous input signal can include an input signal in which the data is sent without a separate clock. The apparatus further includes a comparator or subtractor configured to compare a threshold, output by the integrator, with the asynchronous input signal. In various implementations, the integrator can include a leaky integrator configured to apply a transform in the form 1/(1+s/γ+s²/w+ . . . ), wherein s can be adjusted based on the complex angular frequency of the asynchronous input signal (what characteristic? the frequency?). In various embodiments, the integrator can include a programmable network having a resistance R and a capacitance C, and γ can include 1/(RC). In various embodiments, the integrator can include one or more programmable current sources configured to adjust a level of boost in said frequency-dependent subtraction.

In various embodiments described herein, while systems configured to track and process the input signal can be referred to as an “integrator,” a person having ordinary skill in the art will appreciate that in some embodiments, the integrator does not necessarily perform a pure integration function. In various embodiments, systems configured to track and process the input signal can be referred to as a “past time filter.”

In various implementations, instead of degenerating a differential-pair with an R-parallel-C, (which can provide a low-frequency gain reduction relative to a high-frequency gain, and thus boost), no degeneration is employed. Gain difference at high- vs low-frequency can be obtained via frequency-dependent signal subtraction instead of scaled degeneration. The level of boost can be controlled by altering current instead of switching resistors and capacitors. Accordingly, certain implementations include simplified layout and programmability of the equalizer, which can provide relatively lower parasitics and a more compact layout.

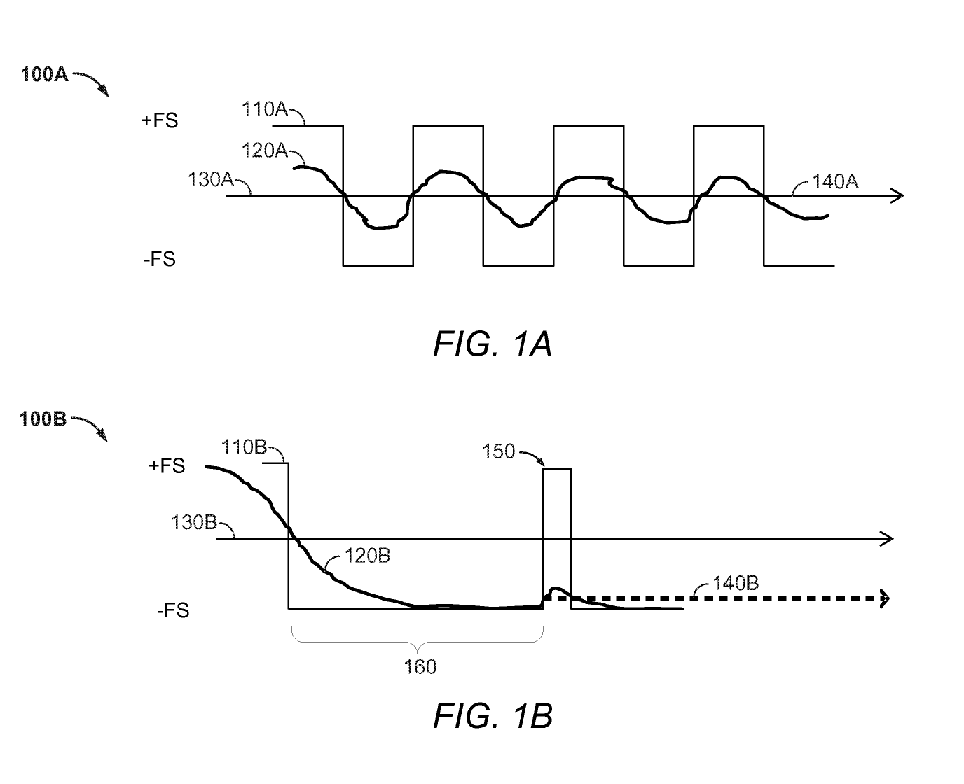

FIG. 1A is an exemplary signal diagram 100A that compares how different data patterns become degraded when transmitted through a lossy channel. The signal diagram 100A shows an input waveform 110A to a lossy channel, and an output waveform 120A from the lossy channel. As shown, the input waveform 110A alternates between positive and negative full scale (FS) on the y-axis, over a period of time represented by the x-axis. The output waveform 120A is attenuated and/or corrupted by the lossy channel. Nevertheless, the input waveform 110A can be recovered at a receiver by equalizing the output waveform 120A based on a zero level 130A, which can also serve as a threshold level 140A.

In the illustrated example, the input waveform 110A alternates every period, representing an input value of 10101010, and so on. Accordingly, its average value is equivalent to the threshold level 140A, which can be variously referred to as 50%, zero level, or 0 mV. In real-world applications, however, the input waveform 110A is unlikely to indefinitely maintain an alternating binary sequence. Accordingly, the output waveform 120A is likely to exhibit additional path dependency, as shown in FIG. 1B.

FIG. 1B is an exemplary signal diagram 100B for a communication channel. The signal diagram 100B shows an input waveform 110B to a lossy channel, and an output waveform 120B from the lossy channel. As shown, the input waveform 110B moves between positive and negative full scale (FS) on the y-axis, over a period of time represented by the x-axis. The output waveform 120B is attenuated and/or corrupted by the lossy channel. Unlike the example discussed above with respect to FIG. 1A, the input waveform 110B cannot be recovered at the receiver simply by equalizing the output waveform 120B based on a zero level 130A.

In the illustrated example, the input waveform 110B starts at +FS and then remains at −FS for an extended period of time before returning to +FS, representing an input value of, for example, 100000100000. Accordingly, by the time the input waveform 110B returns to +FS at a time 150, the output waveform 120B has settled at or near −FS. Thus, when the input waveform 110B returns to +FS for a single period at the time 150, the output waveform 120B does not return above the zero level 130B. In order to correctly recover the input waveform 110B, an alternative strategy can be employed.

In some embodiments, a Bode equalizer (EQ) can be employed. The Bode EQ can separately apply a low-pass filter (LPF) and a high-pass filter (HPF) to the output waveform 120B, apply an additional gain K to the output from the HPF, and sum the outputs from both filters. In this manner, the Bode EQ can create additional gain at higher frequencies (for example, when the output waveform 120B changes at the time 150. However, in some embodiments, the additional gain of the HPF can increase sensitivity to other noise sources in the communication system.

In embodiments of synchronous communication systems, decision feedback equalization (DFE) can be employed. In an exemplary DFE system, the equalized output waveform 120B can be sampled according to a phase-aligned clock signal. The sampled signal can be fed through a digital filter, which can control an equalization threshold 140B fed into a comparator. As discussed, however, in some embodiments DFE can be ineffective in receivers that are not sampled such as, for example, asynchronous routing switches.

In various embodiments, a continuous-time equalization (CTE) system can be employed. An exemplary CTE system can include two signal paths: a main path with a gain A, and a filtered path. The filtered path can include a LPF having a low-frequency gain B, and a high-frequency gain at or around 0, the gain B being less than the gain A. The CTE system can subtract the filtered signal from the main signal, resulting in an overall gain of (A−0)=A at high frequencies, and (A-B) at low frequencies. In this manner, the CTE system can provide boost to the output waveform 120B, and the boosted waveform can be input to a slicer. Accordingly, the effective threshold 140B can be adjusted.

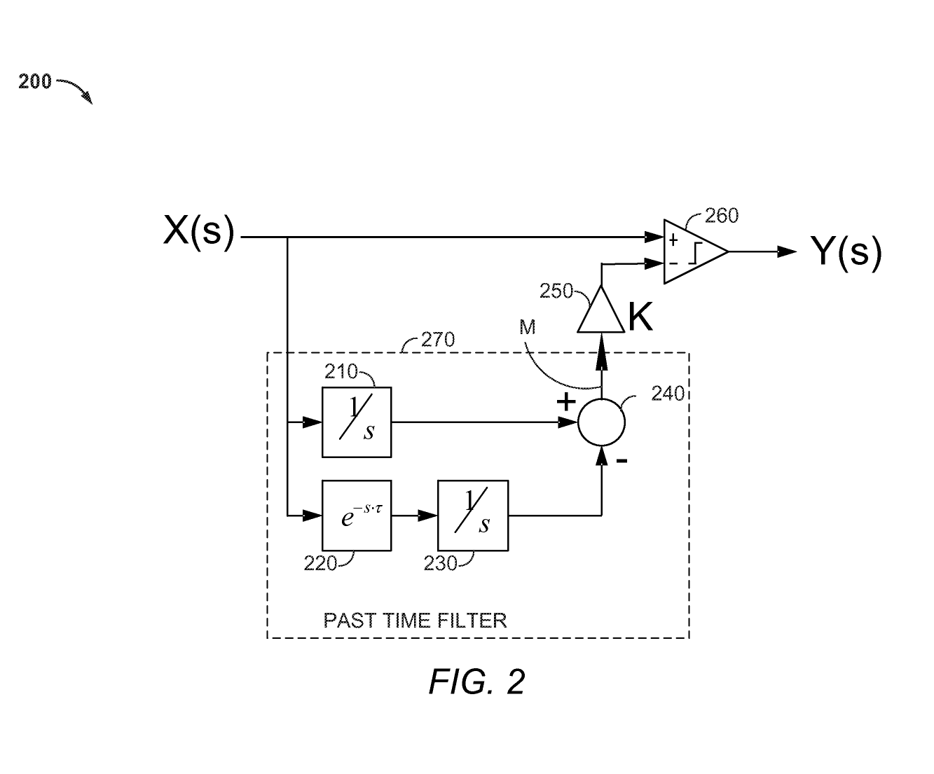

FIG. 2 is a schematic block diagram illustrating one embodiment of a continuous-time equalization (CTE) system 200. The CTE system 200 includes an input signal X(s), a first integrator 210, a delay block 220, a second integrator 230, a subtractor 240, a node M, an amplifier 250, a comparator 260, and an output signal Y(s). Although the CTE system 200 is described herein with reference to particular components arranged in a particular configuration, in various embodiments, components herein can be combined, divided, arranged in a different order, or omitted, and additional components can be added.

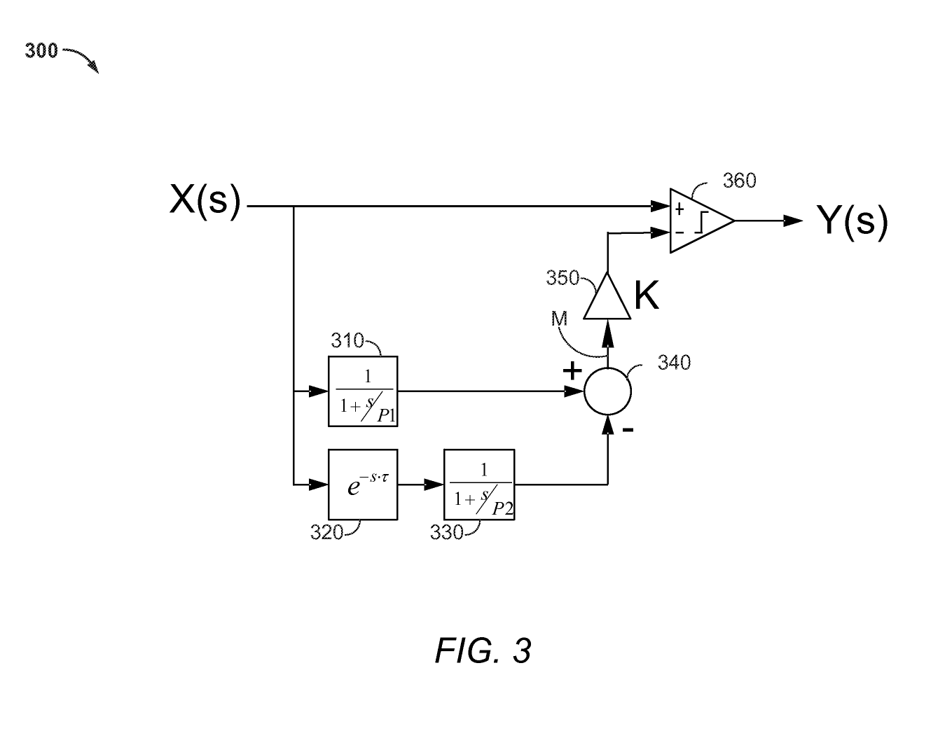

In general, FIG. 2 is an arrangement to dynamically track the input signal in order to alter the threshold of the comparator 260 in such a way that will allow the waveforms of FIGS. 1A-1B to be recovered. Accordingly, although various implementations using integrators are discussed herein, any part time filter can be used. For example, the first integrator 210, the delay block 220, and the second integrator 230 can be replaced with a past time filter 270. The past time filter 270 can be configured to track and process the input X(s) as discussed herein, and need not be implemented using the integrator 210, the delay block 220, or the second integrator 230. Similarly, FIGS. 3-8 include approximations to the continuous-time threshold adjustment discussed herein with respect to FIG. 2, but can be implemented differently.

The first integrator 210 serves to integrate the input signal X(s). In various embodiments, the first integrator 210 can include a diff-pair integrator (DPI). The DPI can include an integration capacitor. In various embodiments, other integrator designs can be employed.

The delay block 220 serves to delay the input signal X(s) by τ seconds. In various embodiments, the delay block 220 can include an analog delay line. In other embodiments, other delay designs can be employed. For example, in some embodiments, the delay block 220 can include an LC Bessel filter.

The second integrator 230 serves to integrate the delayed input signal X(s) received from the delay block 220. In various embodiments, the second integrator 230 can include a diff-pair integrator (DPI). The DPI can include an integration capacitor. In various embodiments, other integrator designs can be employed.

The subtractor 240 serves to subtract the output of the second integrator 230 from the output of the first integrator 210. In various embodiments, the subtractor 240 can include an analog subtraction circuit. In other embodiments, other subtractor designs can be employed. In the illustrated embodiment, the output of the subtractor 240 is shown as node M. In various embodiments, the two integrator paths are configured to perform a window integration over the last τ seconds. Accordingly, the transfer function to node M is shown in Equations 1 and 2, wherein the signal at node M represents information determined from the input signal about where the comparator's threshold should change, and the amount of change is controlled by a scaling factor K:

$$\begin{matrix}{H}_{M} ( s ) = \frac{M ( s )}{X ( s )} = \frac{1}{s} \cdot ( 1 - {e}^{- s \cdot τ} ) = \frac{1}{jω} \cdot ( 1 - {e}^{- jω \cdot τ} ) = \frac{{e}^{- j \cdot ω \cdot τ / 2}}{1 / 2 \cdot ω} \cdot ( \frac{{e}^{- j \cdot ω \cdot τ / 2} - {e}^{j \cdot ω \cdot τ / 2}}{j \cdot 2} ) & ( 1 ) \\ {H}_{M} ( s ) = \frac{{e}^{- j \cdot ω \cdot τ / 2}}{1 / 2 \cdot ω} \cdot sin ( ω \cdot τ / 2 ) = τ \cdot {e}^{- j \cdot ω \cdot τ / 2} \cdot sin c ( ω \cdot τ / 2 ) & ( 2 )\end{matrix}$$

The amplifier 250 serves to apply a gain K to the output of the subtractor 240. In various embodiments, the amplifier 250 can include an analog amplification circuit. In other embodiments, other amplification designs can be employed. In general, varying K will vary the amplitude of the frequency response for the CTE system 200, but should not vary the location of 0-dB points.

The comparator 260 serves to compare a threshold, from the output of the amplifier 250, to the input signal X(s). In various embodiments, the comparator 260 can be implemented as an analog comparator or slicer. In other embodiments, other designs can be employed. The comparator 260 can output the output signal Y(s), which can represent an equalized version of the input signal X(s).

In some embodiments, the comparator 260 can be replaced with a subtractor, such as the subtractor 240, and the result can be provided as an input to a subsequent comparator or slicer. In embodiments where the comparator 260 is replaced with a subtractor, the transfer function to Y(s) is shown in Equations 3 and 4:

$$\begin{matrix}H ( s ) - \frac{Y ( s )}{X ( s )} = 1 - \frac{K \cdot {e}^{- j \cdot ω \cdot τ / 2}}{\frac{1}{2} \cdot ω} \cdot sin ( ω \cdot τ / 2 ) & ( 3 ) \\ H ( s ) = 1 - K \cdot τ \cdot {e}^{- j \cdot ω \cdot τ / 2} \cdot \frac{sin ( ω \cdot τ / 2 )}{ω \cdot τ / 2} = 1 - K \cdot τ \cdot {e}^{- j \cdot ω \cdot τ / 2} \cdot sin c ( ω \cdot τ / 2 ) & ( 4 )\end{matrix}$$

In general, varying τ will generally alter the sinc response for the CTE system 200, as well as the low-frequency gain. In some embodiments, as τ increases, the low-frequency is increasingly integrated away. By way of example, where τ=n/12.5 GHz, the frequency response will have its n-th 0-dB point at 6.25 GHz. Moreover, if τ is set equal to an integer number of bit periods, there will be 0 dB gain at the Nyquist rate.

In some embodiments, making a delay that is longer than a bit period can be inefficient in terms of power consumption, area, and/or design time. For example, LC Bessel filters can occupy significant area. Likewise, smaller active delay circuits can consume significant power. Thus, in some embodiments, the integrators 210 and 230 can be replaced with leaky integrators. In various embodiments, leaky integrators are configured to take the integral of an input, but gradually leak a small amount of input over time. Thus, a CTE with leaky integrators can approximate the windowed subtraction of FIG. 2, with emphasis on the recent past.

FIG. 3 is a schematic block diagram illustrating another embodiment of a continuous-time equalization (CTE) system 300. The CTE system 300 includes an input signal X(s), a first integrator 310, a delay block 320, a second integrator 330, a subtractor 340, a node M, an amplifier 350, a comparator 360, and an output signal Y(s). Although the CTE system 300 is described herein with reference to particular components arranged in a particular configuration, in various embodiments, components herein can be combined, divided, arranged in a different order, or omitted, and additional components can be added.

The first integrator 310 serves to integrate the input signal X(s). In various embodiments, the first integrator 310 can be similar to the integrator 210 discussed above with respect to FIG. 2, but having a rate of leak corresponding to a first pole p1. In various embodiments, additional poles can be included. In various embodiments, the first integrator 310 can include a diff-p air integrator (DPI). The DPI can include an integration capacitor. In various embodiments, other integrator designs can be employed.

The delay block 320 serves to delay the input signal X(s) by τ seconds. In various embodiments, the delay block 320 can include an analog delay line. In other embodiments, other delay designs can be employed. For example, in some embodiments, the delay block 320 can include an LC Bessel filter.

The second integrator 330 serves to integrate the delayed input signal X(s) received from the delay block 320. In various embodiments, the second integrator 330 can be similar to the integrator 230 discussed above with respect to FIG. 2, but having a rate of leak corresponding to a second pole p2. In various embodiments, the second integrator 330 can include a diff-pair integrator (DPI). The DPI can include an integration capacitor. In various embodiments, other integrator designs can be employed.

The subtractor 340 serves to subtract the output of the second integrator 330 from the output of the first integrator 310. In various embodiments, the subtractor 340 can include an analog subtraction circuit. In other embodiments, other subtractor designs can be employed. In the illustrated embodiment, the output of the subtractor 340 is shown as node M. In various embodiments, the two integrator paths are configured to perform a window integration over the last τ seconds, with emphasis on the recent past.

The amplifier 350 serves to apply a gain K to the output of the subtractor 340. In various embodiments, the amplifier 350 can include an analog amplification circuit. In other embodiments, other amplification designs can be employed. In general, varying K will vary the amplitude of the frequency response for the CTE system 300, but does not vary the location of 0-dB points.

The comparator 360 serves to compare a threshold, from the output of the amplifier 350, to the input signal X(s). In various embodiments, the comparator 360 can be implemented as an analog comparator or slicer. In other embodiments, other designs can be employed. The comparator 360 can output the output signal Y(s), which can represent an equalized version of the input signal X(s). In some embodiments, the comparator 360 can be replaced with a subtractor, such as the subtractor 340, and the result can be input to a subsequent comparator or slicer.

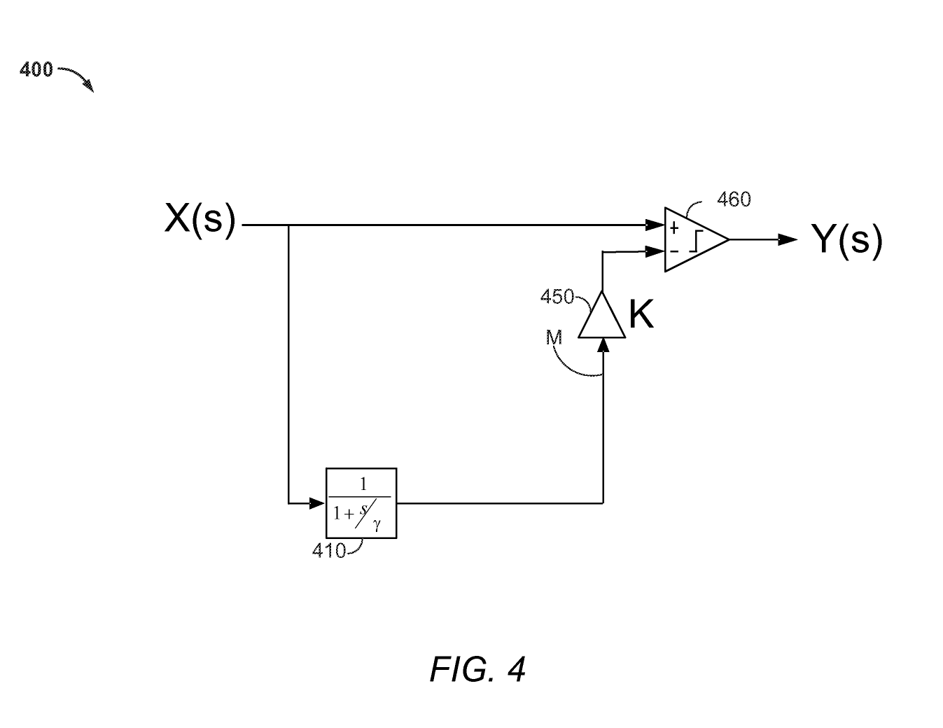

In some embodiments, the CTE system 300 can be approximated by eliminating the delay block 320, particularly when the first and second poles p1 and p2 are relatively far apart. When eliminating the delay block 320, the leaky integrators 310 and 330 can be replaced with a third leaky integrator approximating the two. A CTE system including a leaky integrator approximating the integrators 310 and 330 is shown in FIG. 4.

FIG. 4 is a schematic block diagram illustrating another embodiment of a continuous-time equalization (CTE) system 400. The CTE system 400 includes an input signal X(s), an integrator 410, a node M, an amplifier 450, a comparator 460, and an output signal Y(s). Although the CTE system 400 is described herein with reference to particular components arranged in a particular configuration, in various embodiments, components herein can be combined, divided, arranged in a different order, or omitted, and additional components can be added.

The integrator 410 serves to integrate the input signal X(s). In various embodiments, the integrator 410 can be similar to the integrator 210 discussed above with respect to FIG. 2, but having a rate of leak γ. In various embodiments, γ can be chosen such that the integrator 410 approximates the integrators 310 and 330 and/or the delay block 320 discussed above with respect to FIG. 3. In various embodiments, the integrator 410 can include a diff-pair integrator (DPI). The DPI can include an integration capacitor. In various embodiments, other integrator designs can be employed.

The amplifier 450 serves to apply a gain K to the output of the integrator 410. In various embodiments, the amplifier 450 can include an analog amplification circuit. In other embodiments, other amplification designs can be employed. In general, varying K will vary the amplitude of the frequency response for the CTE system 400, but does not vary the location of 0-dB points.

The comparator 460 serves to compare a threshold, from the output of the amplifier 450, to the input signal X(s). In various embodiments, the comparator 460 can be implemented as an analog comparator or slicer. In other embodiments, other designs can be employed. The comparator 460 can output the output signal Y(s), which can represent an equalized version of the input signal X(s).

In some embodiments, the comparator 460 can be replaced with a subtractor, such as the subtractor 440, and the result can be input to a subsequent comparator or slicer. In embodiments where the comparator 460 is replaced with a subtractor, the transfer function to Y(s) is shown in Equation 5:

$$H ( s ) = \frac{Y ( s )}{X ( s )} = 1 - K \cdot \frac{1}{1 + \frac{s}{γ}} = ( 1 - K ) \cdot \frac{1 + \frac{s}{γ \cdot ( 1 - K )}}{1 + \frac{s}{γ}} \qquad ( 5 )$$

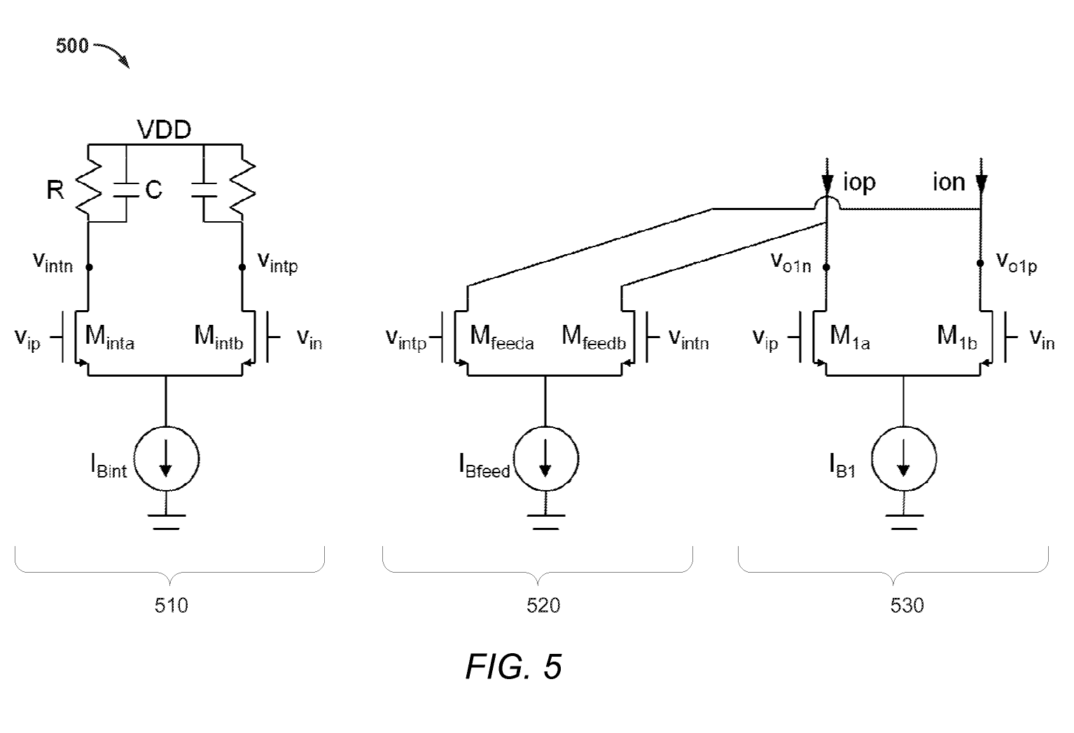

FIG. 5 is a circuit diagram illustrating an embodiment of a continuous-time equalization system 500. In various embodiments, the system 500 can implement, for example, the integrator 410 discussed above with respect to FIG. 4. As shown, the illustrated system 500 includes a leaky integrator 510 (which can implement for example the integrator 410 of FIG. 4), an amplifier 520 (which can implement for example the amplifier 450, having a gain K, of FIG. 4), and a subtraction/comparison circuit 530 (which can implement for example the comparator 460 of FIG. 4).

The system 500 includes a differential input voltage pair Vip and Vin, a differential subtraction/comparison transistor pair M1a and M1b, a differential amplifier transistor pair Mfeeda and Mfeedb, a differential integration transistor pair Minta and Mintb, current sources IB1, IBfeed, and IBint, differential integration nodes Vintn and Vintp, an RC network R and C, and differential output nodes Vo1n and Vo1p. Although the system 500 is described herein with reference to particular components arranged in a particular configuration, in various embodiments, components herein can be combined, divided, arranged in a different order, or omitted, and additional components can be added. For example, although the system 500 is described herein as a differential device, a single-ended device can be employed.

As shown in FIG. 5, the inputs Vip and Vin drive the subtraction/comparison transistors M1a and M1b, respectively. The drains of the subtraction/comparison transistors M1a and M1b are electrically coupled to the output nodes Vo1n and Vo1p, respectively. The sources of the subtraction/comparison transistors M1a and M1b are electrically coupled to a first terminal of the current source IB1. A second terminal of the current source IB1 is electrically coupled to ground.

The inputs Vip and Vin also drive the integration transistors Minta and Mintb, respectively. The drains of the integration transistors Minta and Mintb are electrically coupled to the integration nodes Vintn and Vintp, respectively. The sources of the integration transistors Minta and Mintb are electrically coupled to a first terminal of the current source IBint. A second terminal of the current source IBint is electrically coupled to ground.

The RC network R and C serves to integrate the inputs Vip and Vin at the integration nodes Vintn and Vintp. In various embodiments, the RC network R and C can include one or more separate resistive and capacitive elements. In various embodiments, the RC network R and C can be programmable. For example, the RC network R and C can include one or more transistors or switches configured to selectively connect or disconnect one or more resistive or capacitive elements. Similarly, in various embodiments, the current sources IB1, IBfeed, and IBint can be programmable.

The integration nodes Vintn and Vintp drive the amplifier transistors Mfeeda and Mfeedb, respectively. The drains of the amplifier transistors Mfeeda and Mfeedb are electrically coupled to the output nodes Vo1p and Vo1n, respectively. The sources of the amplifier transistors Mfeeda and Mfeedb are electrically coupled to a first terminal of the current source IBfeed. A second terminal of the current source IBfeed is electrically coupled to ground.

Accordingly, the system 500 can operate according to Equations 6-8, where gmint represents to the gain of the integration transistors Minta and Mintb, gmfeed represents to the gain of the integration transistors Mfeeda and Mfeedb, and gm1 represents to the gain of the integration transistors M1a and M1b:

$$\begin{matrix}{v}_{int} = {v}_{input} \cdot {g}_{mint} \cdot \frac{R}{1 + s \cdot R \cdot C} & ( 6 ) \\ \frac{( iop - ion )}{{v}_{input}} = {g}_{m 1} - {g}_{mfeed} \cdot {g}_{mint} \cdot \frac{R}{1 + s \cdot R \cdot C} & ( 7 ) \\ \frac{( iop - ion )}{{v}_{input}} = ( {g}_{m 1} - {g}_{mint} \cdot {g}_{mfeed} \cdot R ) \cdot \frac{1 + s \cdot \frac{{g}_{m 1} \cdot R \cdot C}{{g}_{m 1} - {g}_{mint} \cdot {g}_{mfeed} \cdot R}}{1 + s \cdot R \cdot C} & ( 8 )\end{matrix}$$

In various embodiments, the rate of leak γ discussed above with respect to FIG. 4 can be 1/(RC) and (1−K) can be equal to (gm1−gmint*gmfeed*R). Accordingly, high-frequency gain can be equal to gm1, and low-frequency gain can be equal to (gm1−gmint*gmfeed*R). Moreover, zero and pole locations can be located according to Equations 9 and 10:

$$\begin{matrix}{ω}_{P} = \frac{1}{R \cdot C} & ( 9 ) \\ {ω}_{Z} = [ \frac{{g}_{m 1} - {g}_{mfeed} \cdot ( {g}_{mint} \cdot R )}{{g}_{m 1}} ] \cdot {ω}_{P} & ( 10 )\end{matrix}$$

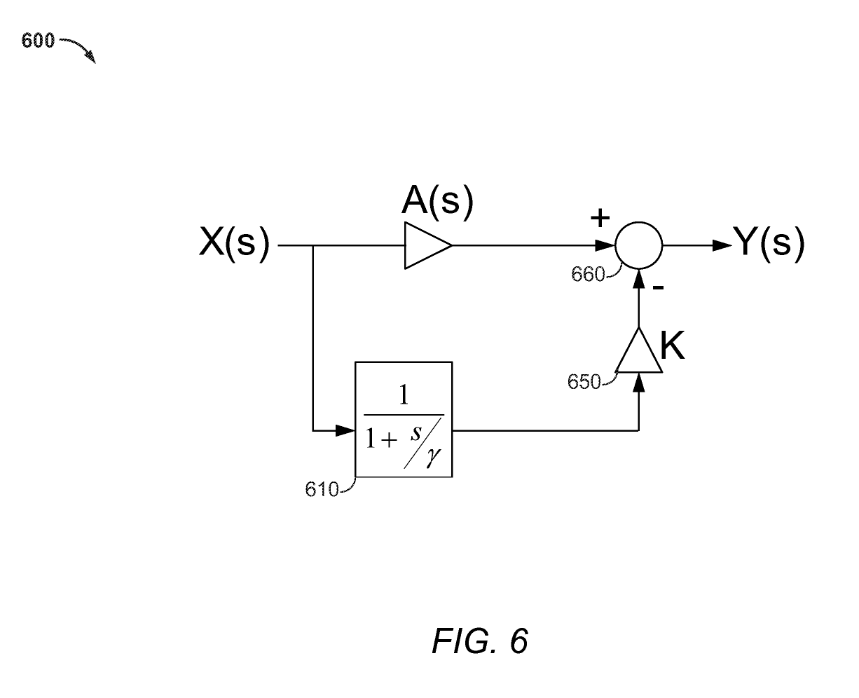

FIG. 6 is a schematic block diagram illustrating another embodiment of a continuous-time equalization (CTE) system 600. The CTE system 600 includes an input signal X(s), a filter A(s), an integrator 610, an amplifier 650, a subtractor 660, and an output signal Y(s). Although the CTE system 600 is described herein with reference to particular components arranged in a particular configuration, in various embodiments, components herein can be combined, divided, arranged in a different order, or omitted, and additional components can be added.

In the illustrated embodiment, the CTE system 600 is a feed-forward configuration. Thus, the main-path of the signal can undergo additional gain/delay/processing before altering the threshold of the comparator. The filter A(s) serves to apply a gain A and a delay τ to the input signal X(s). Accordingly, A(s) can be modeled as Ae^{-sτ}. In various embodiments, A is greater than or equal to K.

The integrator 610 serves to integrate the input signal X(s). In various embodiments, the integrator 610 can be similar to the integrator 210 discussed above with respect to FIG. 2, but having a rate of leak γ. In various embodiments, γ can be chosen such that the integrator 610 approximates the integrators 310 and 330 and/or the delay block 320 discussed above with respect to FIG. 3. In various embodiments, the integrator 610 can include a diff-pair integrator (DPI). The DPI can include an integration capacitor. In various embodiments, other integrator designs can be employed.

The amplifier 650 serves to apply a gain K to the output of the integrator 610. In various embodiments, the amplifier 650 can include an analog amplification circuit. In other embodiments, other amplification designs can be employed. In general, varying K will vary the amplitude of the frequency response for the CTE system 600, but should not vary the location of 0-dB points.

The subtractor 660 serves to subtract the output of the amplifier 650 from the output of the filter A(s). In various embodiments, the subtractor 660 can be implemented as an analog subtraction circuit, an analog comparator, or a slicer. In other embodiments, other designs can be employed. The subtractor 660 can output the output signal Y(s), which can represent an equalized version of the input signal X(s) according to Equation 11:

$$H ( s ) = \frac{Y ( s )}{X ( s )} = A ( s ) - K \cdot \frac{1}{1 + \frac{s}{γ}} = ( A ( s ) - K ) \cdot \frac{1 + \frac{s}{γ \cdot ( A ( s ) - K )}}{1 + \frac{s}{γ}} \qquad ( 11 )$$

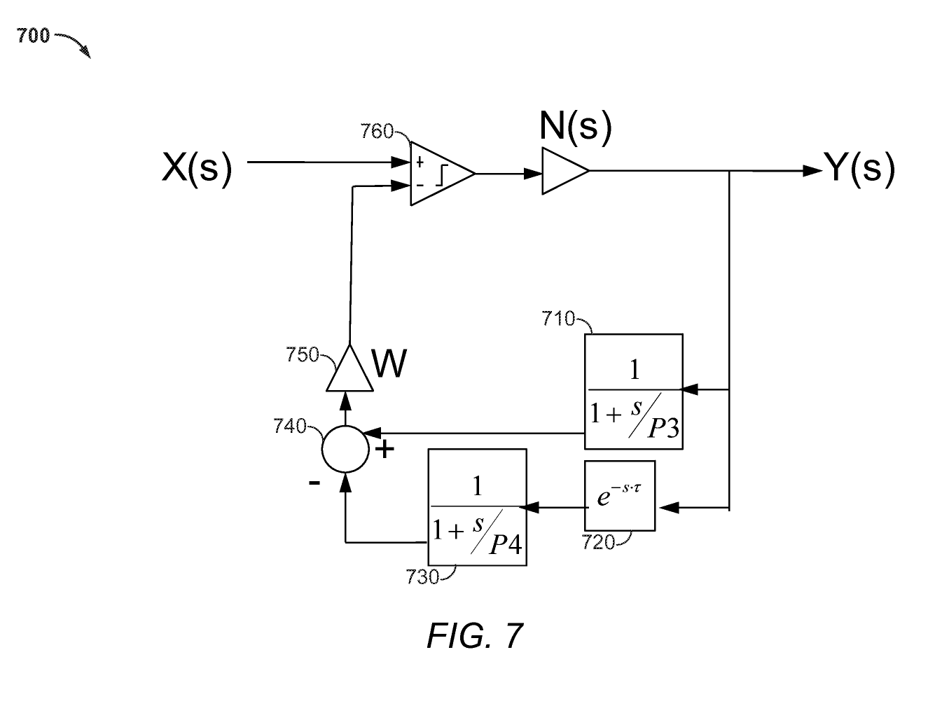

FIG. 7 is a schematic block diagram illustrating another embodiment of a continuous-time equalization (CTE) system 700. In various embodiments, the CTE system 700 can be similar to the CTE system 300 described above with respect to FIG. 3, but in a feed-back design. The CTE system 700 includes an input signal X(s), a first integrator 710, a delay block 720, a second integrator 730, a subtractor 740, an amplifier 750, a comparator 760, a filter N(s), and an output signal Y(s). Although the CTE system 700 is described herein with reference to particular components arranged in a particular configuration, in various embodiments, components herein can be combined, divided, arranged in a different order, or omitted, and additional components can be added.

The first integrator 710 serves to integrate the output from the filter N(s). In various embodiments, the first integrator 710 can be similar to the integrator 210 discussed above with respect to FIG. 2, but having a rate of leak corresponding to a third pole p3. In various embodiments, the first integrator 710 can include a diff-pair integrator (DPI). The DPI can include an integration capacitor. In various embodiments, other integrator designs can be employed.

The delay block 720 serves to delay the output from the filter N(s) by t seconds. In various embodiments, the delay block 720 can include an analog delay line. In other embodiments, other delay designs can be employed. For example, in some embodiments, the delay block 720 can include an LC Bessel filter.

The second integrator 730 serves to integrate the delayed output from the filter N(s) received from the delay block 720. In various embodiments, the second integrator 730 can be similar to the integrator 230 discussed above with respect to FIG. 2, but having a rate of leak corresponding to a fourth pole p4. In various embodiments, the second integrator 730 can include a diff-pair integrator (DPI). The DPI can include an integration capacitor. In various embodiments, other integrator designs can be employed.

The subtractor 740 serves to subtract the output of the second integrator 730 from the output of the first integrator 710. In various embodiments, the subtractor 740 can include an analog subtraction circuit. In other embodiments, other subtractor designs can be employed. In various embodiments, the two integrator paths are configured to perform a window integration over the last τ seconds, with emphasis on the recent past.

The amplifier 750 serves to apply a gain W to the output of the subtractor 740. In various embodiments, the amplifier 750 can include an analog amplification circuit. In other embodiments, other amplification designs can be employed. In general, varying K will vary the amplitude of the frequency response for the CTE system 700, but does not vary the location of 0-dB points.

The comparator 760 serves to compare a threshold, from the output of the amplifier 750, to the input signal X(s). In various embodiments, the comparator 760 can be implemented as an analog comparator or slicer. In other embodiments, other designs can be employed. In some embodiments, the comparator 760 can be replaced with a subtractor, such as the subtractor 740, and the result can be input to a subsequent comparator or slicer.

The comparator 760 can output to the filter N(S), which serves to apply a gain N and a delay τ to its input signal. Accordingly, N(s) can be modeled as Ne^{-sτ}. In various embodiments, N is greater than or equal to W. In various embodiments, N(s) can also represent a general analog filter/processing, not just a gain and pure delay.

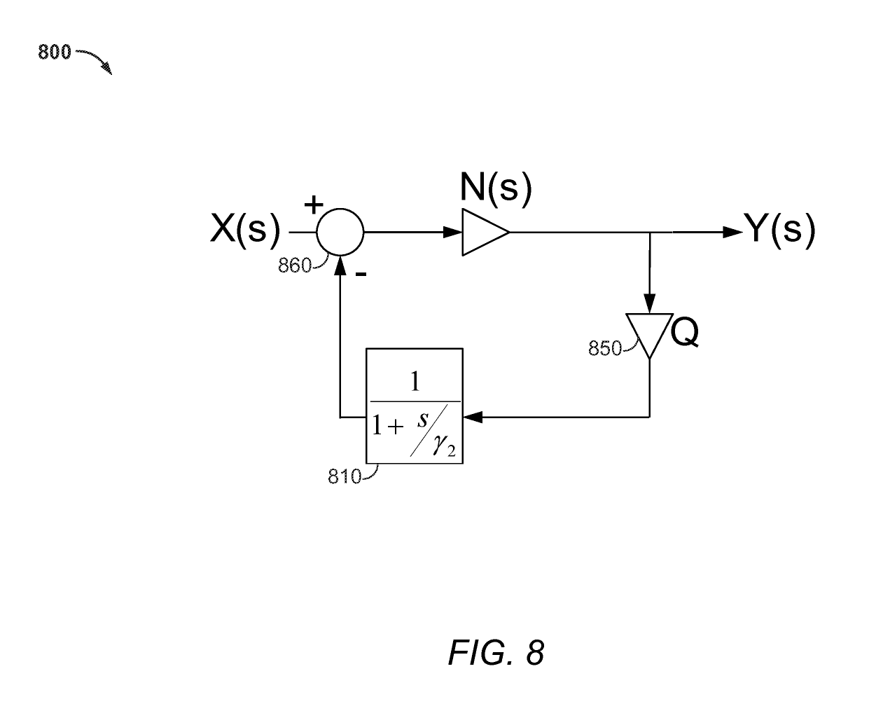

In some embodiments, the CTE system 700 can be approximated by eliminating the delay block 720, particularly when the third and fourth poles p3 and p4 are relatively far apart. When eliminating the delay block 720, the leaky integrators 710 and 730 can be replaced with a third leaky integrator approximating the two. A CTE system including a leaky integrator approximating the integrators 710 and 730 is shown in FIG. 8.

FIG. 8 is a schematic block diagram illustrating another embodiment of a continuous-time equalization (CTE) system 800. In various embodiments, the CTE system 800 can be similar to the CTE system 400 described above with respect to FIG. 4, but in a feed-back design. The CTE system 800 includes an input signal X(s), an integrator 810, an amplifier 850, a subtractor 860, a filter N(s) and an output signal Y(s). Although the CTE system 800 is described herein with reference to particular components arranged in a particular configuration, in various embodiments, components herein can be combined, divided, arranged in a different order, or omitted, and additional components can be added.

The integrator 810 serves to integrate the output from the amplifier 850. In various embodiments, the integrator 810 can be similar to the integrator 210 discussed above with respect to FIG. 2, but having a rate of leak γ. In various embodiments, γ can be chosen such that the integrator 810 approximates the integrators 710 and 730 and/or the delay block 720 discussed above with respect to FIG. 7. In various embodiments, the integrator 810 can include a diff-pair integrator (DPI). The DPI can include an integration capacitor. In various embodiments, other integrator designs can be employed.

The amplifier 850 serves to apply a gain Q to the output of the filter N(s). In various embodiments, the amplifier 850 can include an analog amplification circuit. In other embodiments, other amplification designs can be employed. In general, varying Q will vary the amplitude of the frequency response for the CTE system 800, but does not vary the location of 0-dB points.

The subtractor 860 serves to subtract the output of the integrator 810 from the input signal X(s). In various embodiments, the subtractor 860 can be implemented as an analog subtraction circuit, an analog comparator, or a slicer. In other embodiments, other designs can be employed.

The subtractor 860 can output a signal to the filter N(s), which serves to apply a gain N and a delay τ to its input signal. Accordingly, N(s) can be modeled as Ne^{-sτ}. In various embodiments, N is greater than or equal to Q. The filter N(s) can output the signal Y(s), which can represent an equalized version of the input signal X(s), as shown in Equation 12:

$$H ( s ) = \frac{Y ( s )}{X ( s )} = \frac{N ( s )}{1 + N ( s ) \cdot Q} \cdot \frac{1 + \frac{s}{{γ}_{2}}}{1 + \frac{s}{{γ}_{2} \cdot ( 1 + N ( s ) \cdot Q )}} \qquad ( 5 )$$

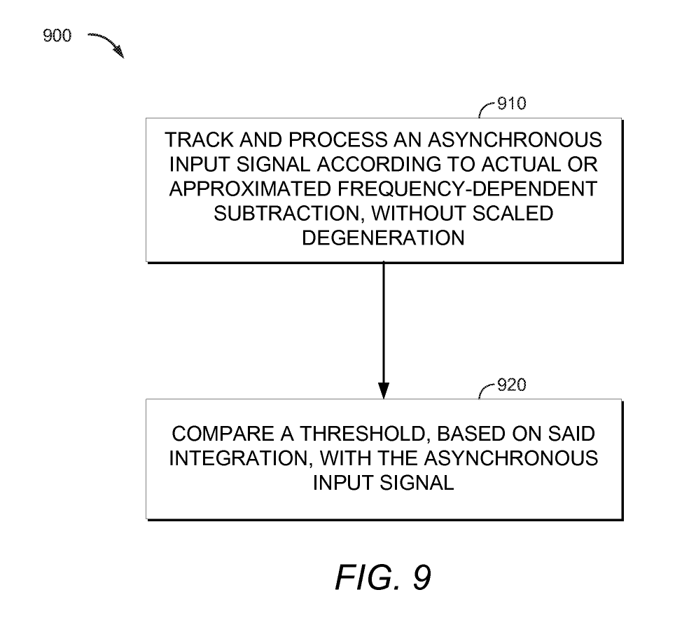

FIG. 9 is a flowchart 900 of an exemplary process of continuous-time equalization. Although the process of flowchart 900 is described herein with reference to the CTE systems 200-400 and 600-800 discussed above with respect to FIGS. 2-4 and 6-8, respectively, and the system 500 discussed above with respect to FIG. 5, a person having ordinary skill in the art will appreciate that the process of flowchart 900 can be implemented by another device described herein, or any other suitable device. In an embodiment, the steps in flowchart 900 can be performed by a processor or controller. Although the process of flowchart 900 is described herein with reference to a particular order, in various embodiments, blocks herein can be performed in a different order, or omitted, and additional blocks can be added.

First, an apparatus tracks and processes an asynchronous input signal according to actual or approximated frequency-dependent subtraction. For example, the CTE system 400 can integrate the input signal X(s) at the integrator 410. The integrator 410 can approximate the subtraction of the output of the integrator 210 from the output of the integrator 230. As another example, the subtractor 240 can actually subtract the output of the integrator 210 from the output of the integrator 230.

In various embodiments, tracking and processing can include applying a transform in the form 1/(1+s/γ+s²/w+ . . . ), wherein s can be adjusted based on the complex angular frequency of the asynchronous input signal. For example, the integrator 410 can apply the transform 1/(1+s/γ) to the input signal X(s). As another example, the integrator 810 can apply the transform 1/(1+s/γ) to a fed-back signal based on the output of the subtractor 860. In various embodiments, such transforms can be the S-domain representation of an integrator. In various embodiments, any transforms described herein can include additional terms.

In various embodiments, tracking and processing can include programming a network having a resistance R and a capacitance C, and γ includes 1/(RC). For example, one or more processors or control logic circuits can program the RC network R and C. Similarly, tracking and processing can include programming one or more current sources configured to adjust a level of boost in said frequency-dependent subtraction. For example, one or more processors or control logic circuits can program the current source IBint, IB feed, and/or IB1.

In various embodiments, tracking and processing can include performing a first sub-integration on the asynchronous input signal, providing a delayed input signal, performing a second sub-integration on the delayed input signal, and subtracting a result of the second sub-integration from a result of the first sub-integration. For example, the integrator 210 can perform the first sub-integration, the delay block 220 can provide the delayed input signal, the integrator 230 can perform the second sub-integration, and the subtractor 240 can subtract the result. As another example, the integrator 310 can perform the first sub-integration, the delay block 320 can provide the delayed input signal, the integrator 330 can perform the second sub-integration, and the subtractor 340 can subtract the result. As another example, the integrator 710 can perform the first sub-integration, the delay block 720 can provide the delayed input signal, the integrator 730 can perform the second sub-integration, and the subtractor 740 can subtract the result.

In various embodiments, performing the first and second sub-integrations can each include applying a transform in the form 1/s, wherein s can be adjusted based on the complex angular frequency of the asynchronous input signal. For example, the integrator 210 can perform the first sub-integration, and the integrator 230 can perform the second sub-integration.

In various embodiments, performing the first sub-integration can include applying a transform in the form 1/(1+s/p1), wherein s can be adjusted based on the complex angular frequency of the asynchronous input signal, and p1 corresponds to a first pole. Performing the second sub-integration can include applying a transform in the form 1/(1+s/p2), wherein s can be adjusted based on the complex angular frequency of the asynchronous input signal, and p\2 corresponds to a first pole. For example, the integrator 310 can perform the first sub-integration, and the integrator 330 can perform the second sub-integration. As another example, the integrator 710 can perform the first sub-integration, and the integrator 730 can perform the second sub-integration.

Next, the apparatus compares a threshold, based on said integration, with the asynchronous input signal. For example, the comparator 460 can compare the output of the integrator 410 (which can be scaled by the amplifier 450) with the input signal X(s). As another example, the subtractor 660 can compare the scaled output of the integrator 610 (which can be scaled by the amplifier 650) with the input signal X(s), which can be filtered by the filter A(s).

In various embodiments, comparing the threshold can include determining the threshold based on a feed-back loop. For example, the subtractor 740 can determine the threshold based on feedback from the output of comparator 760. As another example, the integrator 810 can determine the threshold based on feedback from the output of subtractor 860.

In various embodiments, comparing the threshold can include determining the threshold based on a feed-forward signal flow. For example, the integrator 640 can determine the threshold based directly on the input signal X(s). As another example, the subtractor 660 can determine the threshold based on the filter A(s).

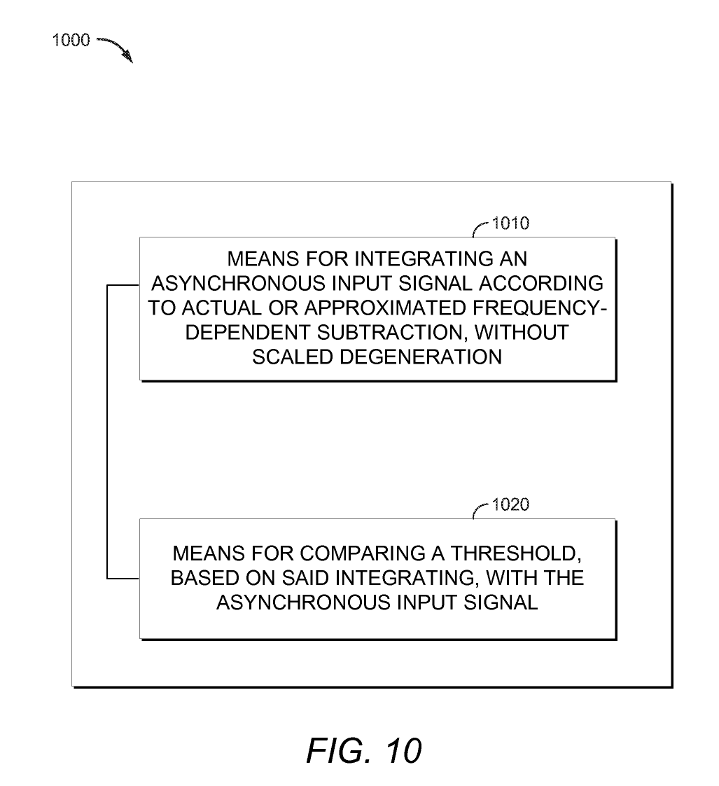

FIG. 10 is a functional block diagram of an apparatus 1000 for continuous-time equalization, in accordance with an embodiment of the invention. Those skilled in the art will appreciate that an apparatus for continuous-time equalization can have more components than the simplified apparatus 1000 shown in FIG. 10. The apparatus 1000 for continuous-time equalization shown includes only those components useful for describing some prominent features of implementations within the scope of the claims. The apparatus 1000 for continuous-time equalization includes means 1010 for integrating an asynchronous input signal according to actual or approximated frequency-dependent subtraction and means 1020 for comparing a threshold, based on said integrating, with the asynchronous input signal.

In an embodiment, means 1010 for integrating an asynchronous input signal according to actual or approximated frequency-dependent subtraction can be configured to perform one or more of the functions described above with respect to block 910 (FIG. 9). In various embodiments, the means 1010 for integrating an asynchronous input signal according to actual or approximated frequency-dependent subtraction can be implemented by one or more of the integrators 210, 230, 310, 330, 410, 500, 610, 710, 730, and 810 (FIGS. 2-8, respectively), the delay blocks 220, 320, and 720 (FIGS. 2, 3, and 7, respectively), the subtractors 240, 340, and 740 (FIGS. 2, 3, and 7, respectively), one or more digital signal processors (DSPs) and/or general purpose processors.

In an embodiment, means 1020 for comparing a threshold, based on said integrating, with the asynchronous input signal can be configured to perform one or more of the functions described above with respect to block 920 (FIG. 9). In various embodiments, the means 1020 for comparing a threshold, based on said integrating, with the asynchronous input signal can be implemented by one or more of the comparators 260, 360, 460, and 760 (FIGS. 2-4 and 7, respectively), one or more of the subtractors 660 and 860 (FIGS. 6 and 8, respectively), one or more digital signal processors (DSPs) and/or general purpose processors.

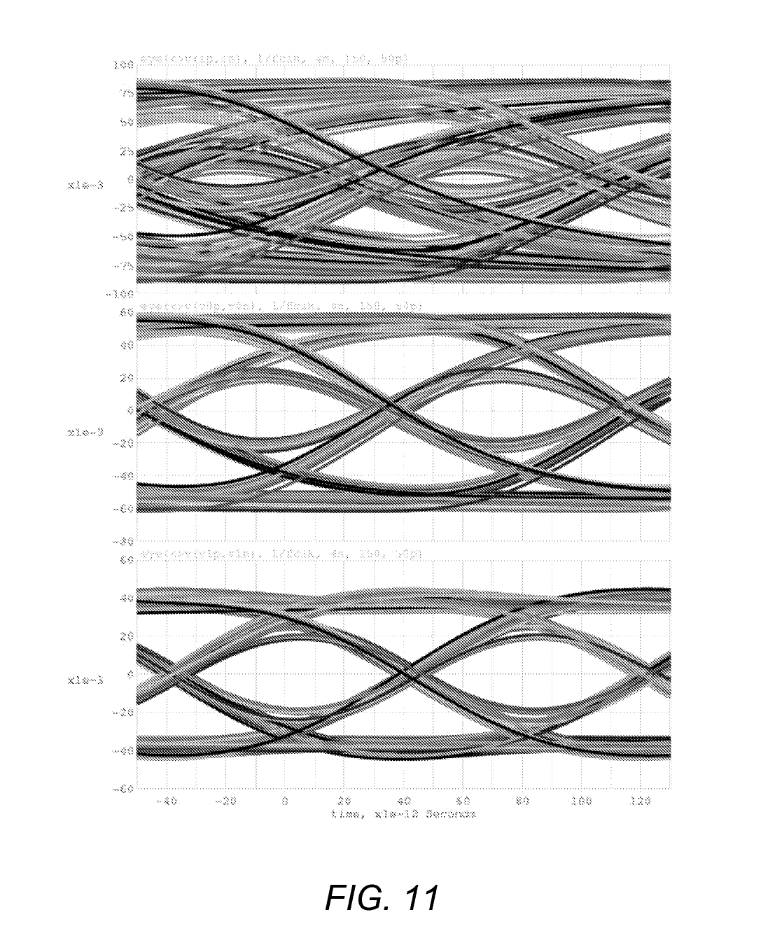

FIG. 11 shows a data eye diagram before and after equalization according to various implementations herein. From top to bottom, FIG. 11 shows eye at the input to two equalization stages, the eye after the first state, and the eye after the second stage. As shown in FIG. 11, the equalization systems and methods described herein can “open” the data eye diagram.

The foregoing description and claims can refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components can be present in an actual embodiment (assuming that the functionality of the depicted circuits is not adversely affected).

### Applications

Devices employing the above described schemes can be implemented into various electronic devices. Examples of the electronic devices can include, but are not limited to, medical imaging and monitoring, consumer electronic products, parts of the consumer electronic products, electronic test equipment, high-speed optical networks, serializer/deserializers, cable modems, etc. Examples of the electronic devices can also include memory chips, memory modules, circuits of optical networks or other communication networks, and disk driver circuits. The consumer electronic products can include, but are not limited to, a mobile phone, a telephone, a television, a computer monitor, a computer, a hand-held computer, a personal digital assistant (PDA), a microwave, a refrigerator, an automobile, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi-functional peripheral device, a wrist watch, a clock, etc. Further, the electronic device can include unfinished products.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

Information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the embodiments of the invention.

The various illustrative blocks, modules, and circuits described in connection with the embodiments disclosed herein can be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein can be embodied directly in hardware, in a software module executed by a processor, or in a combination of the two. If implemented in software, the functions can be stored on or transmitted over as one or more instructions or code on a tangible, non-transitory computer-readable medium. A software module can reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium can be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium can reside in an ASIC. The ASIC can reside in a user terminal. In the alternative, the processor and the storage medium can reside as discrete components in a user terminal.

For purposes of summarizing the disclosure, certain aspects, advantages and novel features of the inventions have been described herein. It is to be understood that not necessarily all such advantages can be achieved in accordance with any particular embodiment of the invention. Thus, the invention can be embodied or carried out in a manner that achieves or optimizes one advantage or group of advantages as taught herein without necessarily achieving other advantages as can be taught or suggested herein.

Various modifications of the above described embodiments will be readily apparent, and the generic principles defined herein can be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
an integrator configured to track and process an asynchronous input signal according to actual or approximated frequency-dependent subtraction to generate a threshold as an output; and
a comparator or subtractor configured to compare the modified threshold with the asynchronous input signal.

2. The apparatus of claim 1, wherein the integrator comprises a leaky integrator configured to apply a transform in the form 1/(1+s/γ+s²/w+ . . . ), wherein s is adjusted based on the complex angular frequency of the asynchronous input signal.

3. The apparatus of claim 2, wherein the integrator comprises a programmable network having a resistance R and a capacitance C, and γ comprises 1/(RC).

4. The apparatus of claim 2, wherein the integrator comprises one or more programmable current sources configured to adjust a level of boost in the frequency-dependent subtraction.

5. The apparatus of claim 1, wherein the integrator comprises:
a first sub-integrator configured to integrate the asynchronous input signal;
a delay circuit configured to provide a delayed input signal;
a second sub-integrator configured to integrate the delayed input signal; and
a subtractor configured to subtract an output of the second sub-integrator from an output of the first sub-integrator.

6. The apparatus of claim 1, wherein the first and second sub-integrators are each configured to apply a transform in the form 1/s, wherein s is adjusted based on the complex angular frequency of the asynchronous input signal.

7. The apparatus of claim 1, wherein:
the first sub-integrator is configured to apply a transform in the form 1/(1+s/p1), wherein s is adjusted based on the complex angular frequency of the asynchronous input signal, and p1 corresponds to a first pole; and
the second sub-integrator is configured to apply a transform in the form 1/(1+s/p2), wherein s is adjusted based on the complex angular frequency of the asynchronous input signal, and p\2 corresponds to a first pole.

8. The apparatus of claim 1, wherein the integrator and comparator or subtractor are configured in a feed-back configuration.

9. The apparatus of claim 1, wherein the integrator and comparator or subtractor are configured in a feed-forward configuration.

10. An electronically-implemented method of continuous-time equalization, the method comprising:
asynchronously integrating an asynchronous input signal according to actual or approximated frequency-dependent subtraction; and
comparing a threshold, based on said integrating, with the asynchronous input signal.

11. The method of claim 10, wherein said integrating comprises applying a transform in the form 1/(1+s/γ+s²/w+ . . . ), wherein s is adjusted based on the complex angular frequency asynchronous input signal.

12. The method of claim 11, wherein said integrating comprises programming a network having a resistance R and a capacitance C, and γ comprises 1/(RC).

13. The method of claim 11, wherein said integrating comprises programming one or more current sources configured to adjust a level of boost in said frequency-dependent subtraction.

14. The method of claim 10, wherein said integrating comprises:
performing a first sub-integration on the asynchronous input signal;
providing a delayed input signal;
performing a second sub-integration on the delayed input signal; and
subtracting a result of the second sub-integration from a result of the first sub-integration.

15. The method of claim 10, wherein performing the first and second sub-integrations each comprise applying a transform in the form 1/s, wherein s is adjusted based on the complex angular frequency of the asynchronous input signal.

16. The method of claim 10, wherein:
performing the first sub-integration comprises applying a transform in the form 1/(1+s/p1), wherein s is adjusted based on the complex angular frequency of the asynchronous input signal, and p1 corresponds to a first pole; and
performing the second sub-integration comprises applying a transform in the form 1/(1+s/p2), wherein s is adjusted based on the complex angular frequency of the asynchronous input signal, and p\2 corresponds to a first pole.

17. The method of claim 10, wherein said comparing the threshold comprises determining the threshold based on a feed-back loop.

18. The method of claim 10, wherein said comparing the threshold comprises determining the threshold based on a feed-forward signal flow.

19. An apparatus for continuous-time equalization, the comprising:
a means for integrating an asynchronous input signal according to actual or approximated frequency-dependent subtraction; and
a means for comparing a threshold, based on said integrating, with the asynchronous input signal.
